(19) United States
(12) Patent Application Publication
(10) Pub. No.: US 2007/0019195 A1
(43) Pub. Date: Jan. 25, 2007

(54) Particle size distribution measuring device

(75) Inventor: Shinichiro Totoki, Kyoto-shi (JP)

Correspondence Address: KANESAKA BERNER AND PARTNERS LLP, SUITE 300, 1700 DIAGONAL RD, ALEXANDRIA, VA, 22314-2848, US

(73) Assignee: SHIMADZU CORPORATION, Kyoto (JP)

(21) Appl. No.: 11/447,202

(22) Filed: Jun. 6, 2006

(30) Foreign Application Priority Data
Jul. 20, 2005 (JP) 2005-210362

(51) Int. Cl. G01N 15/02

(52) U.S. Cl. 356/336

(57) ABSTRACT

A particle size distribution measuring device detects, at a detecting portion, the spatial intensity distribution of diffracted light and scattered light produced by irradiating a sample including a group of particles, with laser light. The measuring device calculates the particle size distribution of the group of the particles using the detected results and has an irradiated area transfer device that allows an irradiated area of the laser light relative to the sample, to be displaced in at least one direction perpendicular to the direction the laser light advanced toward the sample (viz., either one-dimensionally or two-dimensionally), while the sample and detecting portion respectively remain fixed in stationary positions.

### BACKGROUND OF THE INVENTION AND RELATED ART STATEMENT

The present invention relates to a laser diffraction and laser scattering particle size distribution measuring device which measures the particle size distribution of a particle body in a sample including a group of measured particles.

The laser diffraction and laser scattering particle size distribution measuring device (hereinafter referred to as the particle size distribution measuring device or alternatively just device) irradiates the sample including a group of the measured particles such as, for example, particles in a film, particles ejected from a nozzle, and particles in a suspension, wherein the particles are dispersed in a transfer liquid (hereinafter referred to simply as the sample), with laser light. The particle size distribution measuring device measures the spatial intensity distribution of diffracted light and scattered light caused by interactions between the group of the measured particles and laser light. The particle size distribution measuring device calculates the particle size distribution of the group of the measured particles by carrying out a calculation wherein the light intensity distribution follows either van der Mee's scattering theory or Fraunhofer's diffraction theory. For further examples relating to these theories, reference may be had to Japanese Patent Publication No. 10-019757 and Japanese Patent Publication No. 2003-130783.

Hereinafter, the basic configuration and operation of a conventional particle size distribution measuring device will be explained with reference to FIG. 4. In this arrangement, laser light from a laser light source 1 irradiates a sample 5 via a condenser lens 2, spatial filter 3, and collimating lens 4. The laser light is diffracted and scattered by the group of particles under measurement in the sample 5. Usually, the sample 5 is housed in either a sample holder or a flow cell (not shown in the figures, and hereinafter both referred to as a sample cell) which conforms to respective nature such as, for example, ejected particles, particles in the film, the suspension, and so on.

Among the laser light being diffracted and scattered in sample 5, the light being diffracted and scattered forward, is condensed on a light-acceptance surface of a front light condensing sensor 7 via a condensing lens 6, and measured. A concentric circular photodiode array or the like, is used as the front light condensing sensor 7. Scattered light to the side is measured by a side sensor 8, and scattered light to the back is measured by a back sensor 9.

As needed, the back sensor 9 comprises a group of back sensors. Hereinafter, each sensor, i.e., the front light condensing sensor 7, side sensor 8, and back sensor 9 (or the group of the back sensors) are all described as detecting portions.

The light intensity distribution being measured as described above, is entered in respective amplifier (not shown in the figure) which amplifies the output of the detecting portion. Each output is synthesized into a spatial intensity distribution signal of the diffracted and scattered light, by computer. From the spatial intensity distribution signal and a refractive index of the transfer liquid, the particle size distribution of the group of the measured particles is calculated by a heretofore known calculation based on Mee's scattering theory or Fraunhofer's diffraction theory.

In the case wherein the particle size distribution in the sample 5 is different, i.e., in the case wherein a particle diameter distribution of the measured particles is unequal, and a particle with a large diameter is unevenly distributed in a part of the sample 5, the sampling error is large if a measured data of the sample 5 is taken only once, data representative of the entire sample 5 is unavailable. In this case, the sampling error is required to be reduced by transferring the sample 5 relative to the laser light, collecting data with respect to each transfer, and adding and averaging the data by scattering angle. For example, in the above mentioned Japanese Patent Publication No. 10-019757, it is described that the measured data of the scattered light is averaged by moving the sample relative to the laser light.

The structure of a conventional particle size distribution measuring device is as explained above; however, in this structure, the structure of the device becomes complicated so that the manufacturing cost increases, and measuring time and maintenance man-hours increase. More specifically, for the measurement of the sample 5 with spatially different particle size distribution such as, for example; the measurement of the group of the measured particles in the sample 5 such as the above-mentioned solid and mist which are ejected from a nozzle (hereinafter referred to as a dry measurement), or the measurement of the group of the measured particles which are scatted in the film-like sample 5 (hereinafter referred to as a film measurement) and so on, the following are required due to averaging of the data, a decline in the sampling error and so on. An irradiated area of the sample 5 of the laser light is required to be changed in a one-dimensional direction or two-dimensional direction which is perpendicular to the laser light traveling direction, multiple measurements are required with respect to each change of the area.

However, it is very difficult to interlock elements such as a spraying nozzle, compressed-air mixing source, a flow cell which allows passage of the sample 5, and so on, and to transfer them simultaneously in order to change an irradiated position of the sample 5 by the dry measurement. As a result, conventionally, a structure which interlocks and transfers the laser light source 1 and detecting portion was adapted. However, even in this case, in order to assuredly interlock the laser light source 1 and the detecting portion including multiple sensors with a high degree of accuracy, the structure of the device became complicated so that the manufacturing cost increased. Also, since it is difficult even to rapidly transfer each element with a high degree of accuracy while interlocking, each element, the measuring time, maintenance for maintaining accuracy, and the maintenance man-hours increased.

The present invention is directed to provide a method which solves the above-mentioned problems. Further objects and advantages of the invention will be apparent from the following description of the invention.

### SUMMARY OF INVENTION

In order to solve the above-mentioned problems, the present invention comprises a particle size distribution measuring device which detects a spatial intensity distribution of diffracted light and scattered light obtained by irradiating a sample including a group of measured particles with laser light at a detecting portion, and calculates the particle size distribution of the group of the measured particles with use of a detected result. The particle size distribution measuring device includes an irradiated area transfer means which allows an irradiated area of the laser light relative to the sample to be displaced in at least one direction perpendicular to a direction the laser light advances toward the sample, in a state wherein the sample and detecting portion are fixed. (first aspect)

The sample wherein a pipeline for circulating transfer liquid or takeoff cable of a signal and so on are connected, and the detecting portion are fixed, so that only the irradiated area of the laser light is allowed to shift. Accordingly, the number of machine elements related to the shift is reduced, and an irradiated area transfer mechanism is miniaturized and simplified. As a result, a high-speed shift can be carried out with a high degree of accuracy.

The irradiated area transfer means can be transfer means that allows a mirror, which reflects the laser light and changes the light path to shift (second aspect), or can be transfer means which allows a shift of the laser light source (third aspect).

With use of the particle size distribution measuring device according to the first to third aspects, the spatial intensity distribution of each scattered light being obtained by transferring the irradiated area of the laser light through the irradiated area transfer means allows to calculate the particle size distribution of the group of the measured particles with each irradiated area. By this means, when the sample has a different particle size distribution depending on the spatial position, the condition of the difference can be examined.

In addition, with use of the particle size distribution measuring device as noted above, the particle size distribution of the group of the measured particles in the entire irradiated area can be calculated through the spatial intensity distribution wherein the spatial intensity distribution of respective scattered light being obtained by transferring the irradiated area of the laser light by the irradiated area transfer means is integrated or averaged. By this means, even if the particle size distribution of the sample differs depending on the spatial position, an averaged particle size distribution can be measured.

Averaging the spatial intensity distribution is the processing substantially equivalent to integrating the spatial intensity distribution. However, the processing also includes, for example, a weighted averaging processing or the like.

The invention includes means allowing a sample irradiated area to transfer in a one-dimensional direction or two-dimensional direction which is perpendicular to a laser light traveling direction without transferring the detecting portion, so that a transfer or scanning of the detecting portion which was conventionally necessary is rendered unnecessary. As a result, the structure of the device is simplified, so that the manufacturing cost can be reduced, and maintenance man-hours for maintaining accuracy can be reduced.

### BRIEF DESCRIPTION OF THE DRAWINGS

FIGS. 1(A) and 1(B) are drawings showing the structure of a first embodiment of the present invention.

FIG. 2 is a drawing showing the structure of a second embodiment of the present invention.

FIG. 3 is a drawing showing the structure of another embodiment of the present invention; and

FIG. 4 is a drawing showing the structure of a conventional particle size distribution measuring device.

### DETAILED DESCRIPTION OF PREFERRED EMBODIMENTS

A particle size distribution measuring device being proposed in the present invention includes the following features. The first feature is that the particle size distribution measuring device includes the structure of an irradiated area transfer means or device which allows an irradiated area of laser light relative to a sample to transfer in at least one direction perpendicular to the direction in which the laser light advanced toward the sample (viz., either one-dimensionally or two-dimensionally), in a state wherein the sample and a detecting portion are fixed in stationary positions.

The second feature is that the particle size distribution measuring device includes the structure of a transfer means allowing a mirror which reflects the laser light and changes the light path to transfer as the irradiated area transfer means. The third feature is that the particle size distribution measuring device includes the structure of the transfer means allowing a laser light source which generates the laser light to transfer as the irradiated area transfer means.

The fourth feature is that the particle size distribution measuring device includes a structure that a particle size distribution of the group of the measured particles with each irradiated area is calculated through a spatial intensity distribution of respective scattered light which is obtained by transferring the irradiated area of the laser light through the irradiated area transfer means. The fifth feature is that the particle size distribution measuring device includes a structure that the particle size distribution of the group of the measured particles in the entire irradiated area is calculated through the spatial intensity distribution wherein the spatial intensity distribution of respective scattered light which is obtained by transferring the irradiated area of the laser light by the irradiated area transfer means is integrated or averaged. Therefore, the basic structure of one embodiment of the invention is the particle size distribution measuring device with the irradiated area transfer means which allows the irradiated area of the laser light relative to the sample to transfer in a direction perpendicular to the moving direction of the laser light one-dimensionally or two-dimensionally, in a state wherein the sample and the detecting portion are fixed.

### Embodiment 1

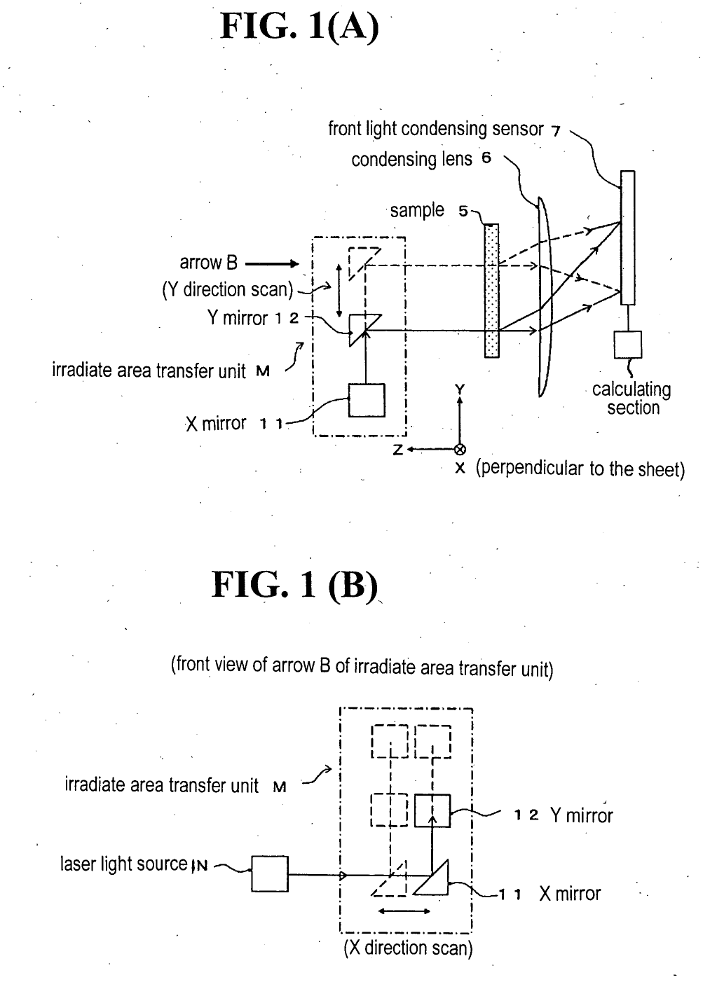

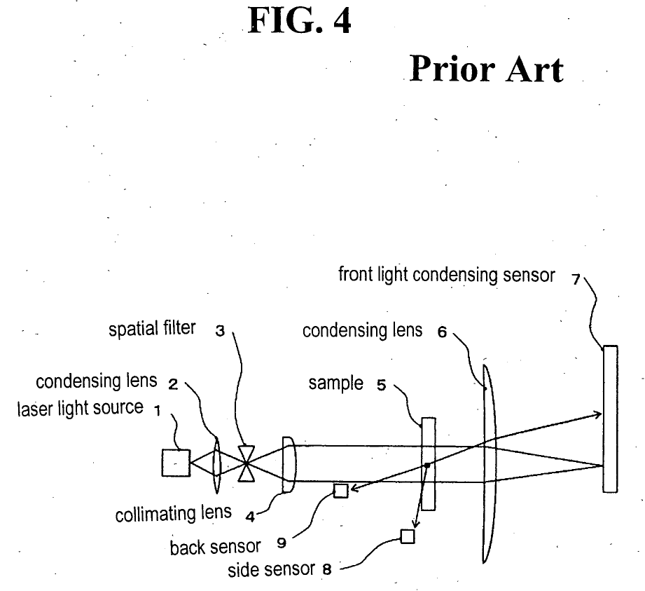

Hereinafter, the present invention will be explained with reference to the figures. FIG. 1(A) is a side view showing the arrangement of a first embodiment of the present invention, and FIG. 1(B) is a front view showing an irradiated area transfer unit M and a laser light source portion 1N. In FIGS. 1(A), 1(B), structures and operations of components with the same symbol as in FIG. 4 are the same as those in FIG. 4.

As shown in FIG. 1(A), a Y-axis and Z-axis of a right-hand system orthogonal coordinate axis are shown along or parallel to the drawing sheet, and an X-axis is shown vertically thereto. The laser light from the laser light source portion 1N is reflected at an X mirror 11 provided on the irradiated area transfer unit M. The laser light is re-reflected at a Y mirror 12 provided on the same irradiated area transfer unit M, and irradiates a sample 5. The X mirror 11 and Y mirror 12 reflect and change the direction of an incident light. In addition, the laser light source portion 1N in FIG. 1(B) includes necessary condensing elements such as a laser light source 1, condenser lens 2, spatial filter 3, and collimating lens 4 in FIG. 4. The laser light source portion 1N is fixed on a basal platform (not shown in the figure).

The irradiated area transfer unit M includes an X-scanning driving platform (not shown in the figure) which allows both of the X mirror 11 and Y mirror 12 to transfer in an X direction or scan; and a Y-scanning driving platform (not shown in the figure) which allows only the Y mirror 12 on the X-scanning driving platform to transfer in a Y direction or scan. Hereinafter, both scanning driving platforms are referred to as a scanning stage. The X mirror 11 and Y mirror 12 are harmoniously transferred on the scanning stage which is built in the irradiated area transfer unit M or scanned, so that irradiated positions of X and Y planar areas of the sample 5 can be transferred or scanned. A combination of a linear stage can be used for the scanning stage.

At a measuring time, the following operations that an XY position is selected, and the data of the particle size distribution is obtained; and the XY position is manually transferred or automatically scanned, and the data of the particle size distribution is obtained, are repeated, and the XY position and obtained data are saved in pairs. Timing in selection for the XY position, laser irradiation, and data acquisition is controlled in a control device (not shown in the figure). In addition, the present invention fixes a positional relation between the sample 5 and detecting portion, and the detecting portion is not interlocked and transferred.

However, in principle, in FIGS. 1(A), 1(B), among the incoming laser light in parallel with a different position of the sample 5, un-scattered light is imaged on a point of a front light condensing sensor 7, i.e., on an optical axis of a condensing lens 6; and the scattered light with a specified scattering angle is imaged in a fixed position off the optical axis. In other words, even if an incident position to the sample 5 differs, both un-scattered light and the same light with the scattering angle condense in a specified position respectively. As a result, when the detecting portion is not interlocked and transferred, even allowing for a cross-sectional area of the laser light of an usual device; disposition and performance of an optical system; aberration of the condenser lens and so on, for example, if a transfer of the irradiated positions of the X and Y planar areas of the sample 5 is limited within the limits of a few centimeters square, the difference can be ignored in principle, and there is no special problem. Also, according to the present invention, the particle size distribution of every data can be swiftly obtained from measured data in each measured position (XY position) of the sample 5.

Moreover, according to the invention, the particle size distribution of the group of the measured particles of the entire irradiated area of the laser light can be obtained by the spatial intensity distribution which is integrated or averaged by carrying out integrating processing or averaging processing of the measured data of each measured position of the sample 5.

### Embodiment 2

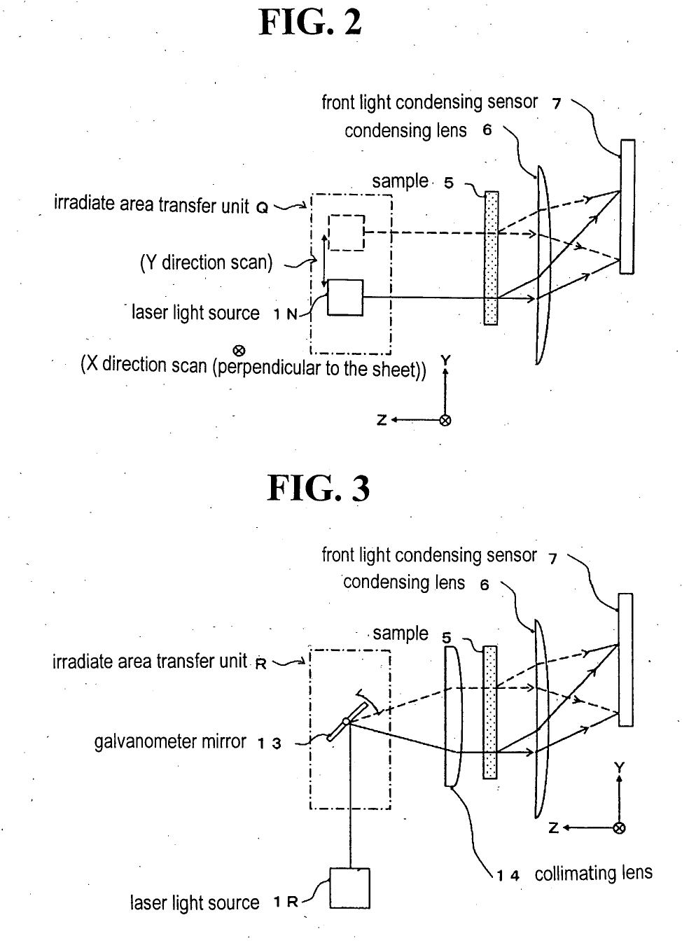

FIG. 2 is a side view showing the arrangement of a second embodiment of the present invention. In FIG. 2, structures and operations of components with the same symbol as in FIG. 1 or FIG. 4 are the same as those in FIG. 1 or FIG. 4. The laser light source portion 1N is mounted on an XY scanning stage (not shown in the figure) being disposed in an irradiated area transfer unit Q, and the irradiated positions of the X and Y planar areas of the sample 5 can be transferred or scanned by transferring the laser light in an X direction and Y direction or scanning. The combination of the linear stage can be used for the XY scanning stage. Even in this embodiment, as with the embodiment 1, the particle size distribution of every data can be swiftly obtained by the measured data in each measured position of the sample 5. Also, obviously, the particle size distribution of the group of the, measured particles of the entire irradiated area of the laser light can be obtained by the spatial intensity distribution which is integrated or averaged.

The present invention is not limited to the embodiments described hereinabove, and various modified embodiments can be provided. For example, the laser light source portion 1N in the embodiment 1 is explained as including the necessary condensing elements such as the laser light source 1, condenser lens 2, spatial filter 3, and collimating lens 4 in FIG. 4; however, according to need of light condensing, a portion such as the condenser lens 2, spatial filter 3, or collimating lens 4 may be separately provided from the laser light source 1, and disposed between the X mirror 11 and Y mirror 12, and the sample 5.

Accordingly, the disposition method of the condensing element of the present invention is not limited. Also, due to a combination of both functions of the irradiated area transfer unit M and irradiated area transfer unit Q in the embodiments 1 and 2, the transfer or scanning in an one-dimensional direction, for example, a Y direction, is carried out by the Y mirror 12 of the irradiated area transfer unit M, and the transfer or scanning in an X direction is carried out by the laser light source portion 1N of the irradiated area transfer unit Q cooperatively with the irradiated area transfer unit M. Two-dimensional scanning of the irradiated area may be carried out by the above-mentioned combination.

In addition, as shown in FIG. 3, instead of the irradiated area transfer unit M wherein the X mirror 11 or Y mirror 12 in the embodiments 1 is used, the scanning can be carried out by oscillating a galvanometer mirror 13 using a laser light source portion 1R consisting of the laser light source 1, condenser lens 2, and spatial filter 3 (refer to FIG. 4); the irradiated area transfer unit R wherein the galvanometer mirror 13 is built in; and a collimating lens 14. Moreover, FIG. 3 shows the case of a one-dimensional scanning; however, two-dimensional scanning can be carried out by a combination of the galvanometer mirror 13. Also, instead of the galvanometer mirror 13, the irradiated area transfer unit R may be constituted by using another structure such as a polygon mirror and so on. The present invention includes all the components described hereinabove.

The present invention can be applied to a laser diffracting and laser scattering particle size distribution measuring device which measures the particle size distribution of a particle body in the sample including the group of the measured particles.

The disclosure of Japanese Patent Application No. 2005-210362 filed on Jul. 20, 2005 is incorporated herein as a reference.

While the invention has been explained with reference to the specific embodiments of the invention, the explanation is illustrative and the invention is limited only by the appended claims.

What is claimed is:

1. A particle size distribution measuring device, comprising:
a sample including a group of particles,
laser light to be irradiated to the sample,
a detecting portion for detecting spatial intensity distribution of diffracted light and scattered light produced by irradiating the sample with the laser light,
a calculating section for calculating particle size distribution of the group of the particles with a detected result, and
an irradiated area transfer device which allows an irradiated area of the laser light relative to said sample, to be displaced in at least one direction perpendicular to a direction the laser light advances toward the sample, in a state wherein said sample and detecting portion are respectively fixed in stationary positions.

2. A particle size distribution measuring device according to claim 1, wherein said irradiated area transfer device includes a mirror and a transfer device for allowing the mirror, which reflects said laser light and changes a light path, to be shifted with respect to the sample.

3. A particle size distribution measuring device according to claim 1, wherein said irradiated area transfer device is a transfer device allowing a laser light source which generates said laser light to be shifted with respect to the sample.

4. A particle size distribution measuring device according to claim 1, wherein said calculation section calculates the particle size distribution of the group of the measured particles with each irradiation area from the spatial intensity distribution of each scattered light obtained by transferring the irradiated area of the laser light through said irradiated area transfer device.

5. A particle size distribution measuring device according to claim 1, wherein said calculation section calculates the particle size distribution of the group of the measured particles in an entire irradiated area through the spatial intensity distribution wherein the spatial intensity distribution of respective scattered light being obtained by transferring the irradiated area of the laser light by said irradiated area transfer device, is integrated or averaged.

6. A particle size distribution measuring device according to claim 1, wherein said irradiated area transfer device comprises a mirror arrangement for reflecting the laser light from a laser source through the stationary sample to a stationary sensor arrangement comprising at least in part said stationary detecting portion, the mirror arrangement being movable and arranged to shift a position in which the laser passes through the sample so as to enable the sample to be scanned in at least one dimension.

7. A particle size distribution measuring device according to claim 6, wherein said mirror arrangement comprises a first mirror and a second mirror which are moved together in one direction while the second mirror is arranged to move in another direction perpendicular the one direction.
